(19) United States
(12) Patent Application Publication
(10) Pub. No.: US 2007/0011282 A1
(43) Pub. Date: Jan. 11, 2007

(54) System and method for performing a distributed configuration across devices

(75) Inventors: Arun C. Alex, Bartlett, IL (US); Kunnath Sudhir, Bolingbrook, IL (US); Abhishek Sharma, Streamwood, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 11/168,827

(22) Filed: Jun. 28, 2005

(51) Int. Cl. G06F 15/177

(52) U.S. Cl. 709/220

(57) ABSTRACT

A configuration of application cards operating in a cluster is synchronized. At least one (100) of the plurality of application cards operating in the cluster, a textual Management Information Base (MIB) file is compiled into a compiled file. The compiled file comprises shared objects and unshared objects. The compiled file is stored in a data base (102). A Simple Network Management Protocol (SNMP) command that identifies a target object is then received. The target object is compared to the shared objects in the compiled file in the database (102), and, when a match exists between the target object and a shared object in the database (102), the SNMP command is replicated using a backplane to access all others (115) of the plurality of application cards operating in the cluster. An operation is then performed on any instance of the target object on all others (115) of the plurality of application cards.

### RELATED APPLICATIONS

This application relates to the following patent applications as were filed on even date herewith (wherein the contents of such patent applications are incorporated herein by this reference):

METHOD AND APPARATUS USING MULTIPLE APPLICATION CARDS TO COMPRISE MULTIPLE LOGICAL NETWORK ENTITIES (attorney's docket number 85234); and PACKET DATA ROUTER APPARATUS AND METHOD (attorney's docket number 85235).

### FIELD OF THE INVENTION

The field of the invention relates to performing configuration procedures among cooperating devices in a network.

### BACKGROUND OF THE INVENTION

Network functions such as home agent (HA) functions and packet data serving node (PDSN) functions are performed at various hardware platforms within communication networks. The platforms themselves can be comprised of one or more application cards. Additionally, groups of cards can be organized into clusters. An Internet Protocol (IP) address is usually associated with each of the cards in the cluster and network functions may be performed by a single or among multiple cards within the cluster.

The cards used on hardware platforms can be organized into different types. For example, application cards may be used to perform HA and PDSN functions within the system. In another example, system manager cards may be used to manage the application cards.

Communication protocols are typically used within these systems so that the various cards can communicate effectively with other network entities and amongst themselves. One example of a protocol is the Simple Network Management Protocol (SNMP). In this protocol, SNMP objects, present on the cards, are initialized, changed, and read allowing the cards to operate and perform their functions.

Previous systems associated a separate IP address with each of the cards of the cluster. Consequently, system efficiency was reduced because the system had to track and process multiple addresses. Another problem with previous systems was that a uniform configuration was difficult to maintain for an object that was stored on multiple cards. In one example of this problem, a change made to the object on one card required the changing of all instances of the object on all cards in the cluster. Because separate IP addresses were used for each card, the reading and modifying of the object would have to be done separately on each card. This could lead to inconsistencies in the cluster operation if there is a finite time delay in the modification of these objects on the individual cards or if there is a failure in a modification operation on one of the cards of the cluster.

### BRIEF DESCRIPTION OF THE DRAWINGS

FIG. 1 is a block diagram of a system for that maintains uniform configuration of devices according to an embodiment of the present invention;

FIG. 2 is a block diagram of a data structure used in a system to maintain the uniform configuration of devices according to an embodiment of the present invention;

FIG. 3 is a flowchart of one example of the processing of an SNMP set request according to an embodiment of the present invention;

FIG. 4 is a flowchart of one example of the loading of configuration information on an application card according an embodiment of to the present invention; and

FIG. 5 is a flowchart of one approach for saving configuration information from an application card according to an embodiment of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method for performing distributed configuration on a plurality of cards in a cluster of cards results in a uniform configuration being achieved and maintained on all cards of the cluster. Consequently, a single IP address can be applied to and used to access configuration information (e.g., an object) located on some or all cards of the cluster thereby ensuring faster and more efficient network operation.

In many of these embodiments, application cards operating together as a cluster are synchronized. A textual Management Information Base (MIB) file may be compiled into a compiled file and stored in a data base. The compiled file may include shared and unshared objects. A Simple Network Management Protocol (SNMP) command, which identifies a target object and an operation to be performed, is then received. The target object is compared to the shared objects in the compiled file in the database. When a match exists between the target object and a shared object in the database, the SNMP command is replicated using a backplane to access all others of the cards operating in the cluster. The operation is then performed upon any instance of the target object on all other cards.

The operation performed may include reading an object (an “object-to-be-read”) or modifying an object (an “object-to-be-modified”). If a modification operation is to be performed, the object-to-be-modified may be tested on all others of the application cards to determine whether the modifying can be performed successfully. When the testing indicates that the modifying cannot be made successfully, any instance of the object will not be modified. On the other hand, when the testing indicates the modifying can be made successfully, all instances of the object may be modified.

In others of these embodiments, synchronization is achieved when new cards are added to the cluster and when objects are saved. In this regard, shared objects in the compiled file in the database may be locked when a new application card is added to the cluster or when the shared objects are being saved.

In others of these embodiments, a property (or attribute) is attached to an object, which may be received by a compiler in a textual file. A property is then attached to the object by the compiler. In attaching the property, the compiler may parse the textual file to determine the property of the object. The property may be a shared property or an unshared property. The object is thereafter compiled and sent to a database, for example, the database on an application card.

Thus, the approaches described herein allow synchronization to be achieved among multiple cards in a cluster. Synchronization is maintained even as objects are changed, new cards are added, and objects are saved. The synchronization allows a single IP address to be used for all cards of the cluster. Consequently, a simpler network design is provided, thereby increasing operational efficiency of the network.

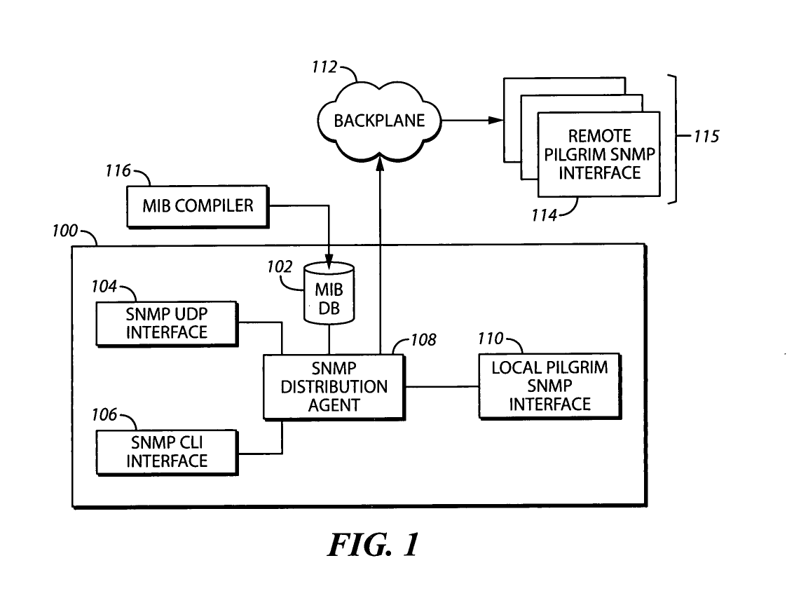

Referring now to FIG. 1, one example of a system for providing a uniform configuration across multiple devices is described. An application card 100 includes a Simple Network Management Protocol (SNMP) interface 104, an SNMP Command Line Interface (CLI) 106, an SNMP distribution agent 108, a Management Information Base (MIB) database 102, and a Local Pilgrim SNMP interface 110.

The SNMP interface 104 allows connections to be made with a client device, such as a personal computer. The SNMP CLI 106 receives commands, for example, SNMP get and set commands, from a user. The Local Pilgrim SNMP interface 110 provides an interface to the applications on the card 100.

The MIB database 102 stores compiled objects and information that indicates whether the objects are shared or not shared. Shared objects contain information that is common to all cards of the cluster. For instance, when used in a Packet Data Serving Node (PDSN) application, Authentication, Authorization, and Accounting (AAA) configuration, Point-to-Point (PPP) configuration, or Internet Protocol (IP) configuration, the shared objects may include configuration information.

Non-shared objects contain information that is specific to a card. For instance, information such as the per-port Medium Access Control (MAC) address may be represented as non-shared objects.

The SNMP distribution agent 108 is responsible for synchronizing SNMP updates between the members of the cluster. The SNMP distribution agent 108 taps all the SNMP Protocol Data Units (PDUs) between the pilgrim application interface 110 and the SNMP interface 104 and the SNMP CLI 106. The SNMP distribution agent 108 performs a lookup of the Object Identifiers (OIDs) for the request in the MIB database 102 generated by a MIB compiler 116. Depending upon the attributes of the OID, the information (i.e., the SNMP PDU) is replicated and distributed to all the members of the cluster. In one example, the distribution agent compares the information in the request to see if the requested information (e.g., an object) is shared or non-shared. If the object is a shared object, then the system performs the indicated operation (e.g., read or write) on the information on the other application cards 115 via a backplane 112 and a remote Pilgrim SNMP interface 114 present on the other cards 115. If the comparison indicates a non-shared object, the system performs the indicated operation only on the object on the card 100.

Shared configuration information is maintained in a shared.cfin file and the non-shared information is maintained in a primary.cfm file. Each card preferably loads its specific private.cfin file, and will load the common shared.cfin file when it loads its configuration. New attributes are defined in the MIB database 102 to make the system know of the shared configuration.

The compiler 116 compiles a MIB file into compiled objects that are stored in the database 102. Different types of objects may be associated with different attributes by a compiler. In one example, a textual MIB file is input into the compiler. As a standard notation, a “--” qualifier is used to denote a comment in the MIB file, and this comment can be used to provide additional information about the object to the MIB compiler. In one example, a, “--configurable” qualifier is included in the MIB file and identifies whether the MIB is configurable or not. This attribute is extended with additional qualifiers to provide the MIB compiler with information to generate code for accessing different classes of MIB objects.

In another example of an attribute, a “--nonshared” qualifier indicates card-specific information. In still another example, a “--shared” qualifier represents information shared between the cards.

A System Manager card (not shown) may be used to configure the clusters within a chassis. When a cluster is configured, a shared configuration directory is created in the system manager for each cluster. The shared directory is linked to each slot that is a member of the cluster. The information concerning the clusters is stored in a dedicated file, for example, a cluster.cfg file.

In one example of a configuration operation, to configure a cluster, a user supplies the cluster ID, application type (e.g., PDSN or HA), and a list of the slot numbers for the cards that form this cluster. Since all the cards in the cluster have a common configuration, a new shared.cfm file may be created that contains the common configuration. This shared.cfm file, filter files, and policy files are stored in the shared configuration directory.

Each cluster may also have at least one redundant card configured. The mechanism to configure the redundancy group may be retained on the system manager card. The application running on the cards loads private configuration from the system manager per slot directory. It also loads the shared configuration and other files from the shared configuration directory.

In one example of the operation of the system in FIG. 1, a textual Management Information Base (MIB) file is compiled into a compiled file at the compiler 116. The compiled file comprises shared objects and unshared objects and is stored in the data base 102. A Simple Network Management Protocol (SNMP) command that identifies a target object is then received at the interface 104 or CLI 106. The target object is compared to the shared objects in the compiled file in the database 102, and, when a match exists between the target object and a shared object in the database, the SNMP command is replicated using the backplane 112 to access all others of the plurality of application cards operating in the cluster. An operation is then performed on any instance of the target object on the all of the other cards 115.

The operation performed may include reading (e.g., SNMP get) or modifying (e.g., SNMP set) an object. If a modification operation is to be performed, the object-to-be-modified may be tested on all other cards 115 in the cluster to determine whether the modifying can be performed successfully. When the testing indicates that the modifying cannot be made successfully, any instance of the object will not be modified. On the other hand, when the testing indicates the modifying can be successful on the all others of the application cards, then all instances of the object may be modified.

In another example, shared objects in the compiled file in the database 102 may be locked when a new application card is added to the cluster. In another example, shared objects in the compiled file in the database 102 may be locked when the shared objects are being saved.

In an example of the operation of the compiler 116, an object may be received at the compiler 116 in a textual file. A property (or attribute) is then attached to the object by the compiler 116. The property may be a shared property or an unshared property. The object is thereafter sent to the data base 102. When attaching the property, the compiler 116 may parse the textual file to determine the property of the object.

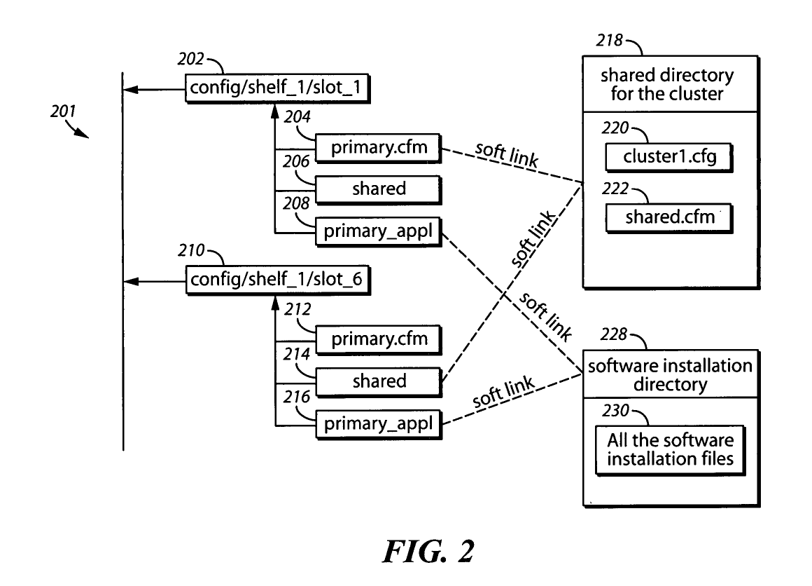

Referring now to FIG. 2, one example of the directory structure for storing information related to objects is described. This structure may be stored at the system manager. A shared directory 218 for each cluster of the chassis contains configuration files that are common to all application cards in the cluster. The directory 218 includes a cluster configuration file 220, and a shared configuration file 222. Other types of files such as policy and filter file and redundancy group files may also be included. A software installation directory 228 includes files 230 that are used to install software in the system.

The cluster configuration file (cluster.cfg) 220 contains information about the cluster, ports, and their association in the chassis. The primary owner of the cluster configuration file 220 is the system manager.

The shared configuration file (shared.cfin) 222 contains the configuration parameters for the pilgrim processes that are needed to provide the functionality (e.g., PDSN or HA functionality). All the application cards in the cluster have read-write access to this configuration file.

Another directory structure 201 includes structures related to particular slots in a cluster. For example, slot identifiers 202 and 210 identify the first and sixth slots in a chassis of the cluster. Each directory may also have subdirectories/files. For instance, slot 202 has a primary file 204 and slot 210 has a primary file 212. The primary files 204 and 212 contain card-specific configuration information. Shared pointers 206 and 214 point to the shared file 222 while primary application pointers 208 and 216 point to the application files 230.

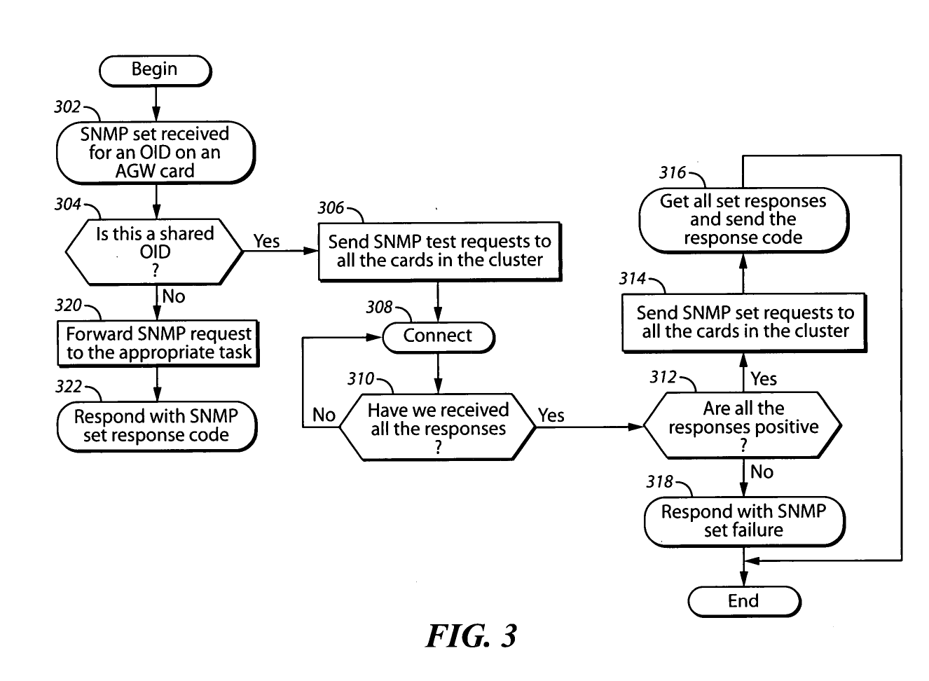

Referring now to FIG. 3, one example of an approach for processing an SNMP set request is described. It will be understood that the approach described with respect to FIG. 3 can also be applied to an SNMP get request. At step 302, an SNMP set request for an object identifier (OID) is received on an application card. At step 304, it is determined if the OID indicates a shared or non-shared object. If the answer is negative, then execution continues at step 320 where the SNMP request is forwarded to the appropriate task. At step 322, the task responds with the appropriate response code.

If the answer at step 304 is affirmative, then at step 306, a SNMP test command is sent to all cards in the cluster. At step 308, the system waits for a response while connections are made with the other cards. The response identifies whether the operation can be performed successfully. At step 310, it is determined whether responses have been received from all the cards. If the answer is negative, control continues at step 308. If the answer is affirmative, then control continues at step 312.

At step 312, it is determined whether all the responses are positive. In another words, it is determined whether a connection can be successfully accomplished. If the answer is negative, at step 318, an SNMP set failure is formed and sent to an appropriate device (e.g., the system manager) to indicate the failure. If the answer at step 312 is affirmative, then at step 314 the SNMP set command is sent to all cards in the cluster. At step 316, all set responses are sent and a response code is sent.

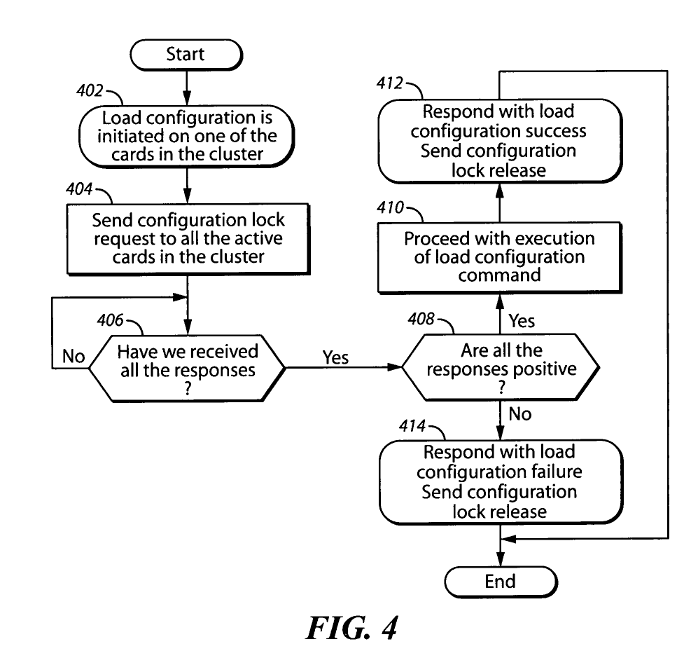

Referring now to FIG. 4, one example of an approach for loading configuration information is described. At step 402, the loading of configuration information is initiated at one of the cards of the cluster. At step 404, a configuration lock request is sent to all the active cards in the cluster. At step 406, it is determined if all responses to the configuration lock requests have been received. If the answer is negative, control returns to step 406. If the answer is affirmative, then at step 408, it is determined whether all of the responses are positive. If the answer is negative at step 408, then at step 414 a load configuration failure is formed and sent to the appropriate device (e.g., the system manager and/or other cards in the cluster). A configuration lock release is also sent to all active cards in the cluster. If the answer is affirmative, execution continues at step 410.

At step 410, execution of the load configuration command proceeds with the loading of the configuration information. At step 412, the card responds with a load configuration success to the appropriate device (e.g., the system manager and/or other cards in the cluster). A configuration lock release is also sent to all the active cards in the cluster.

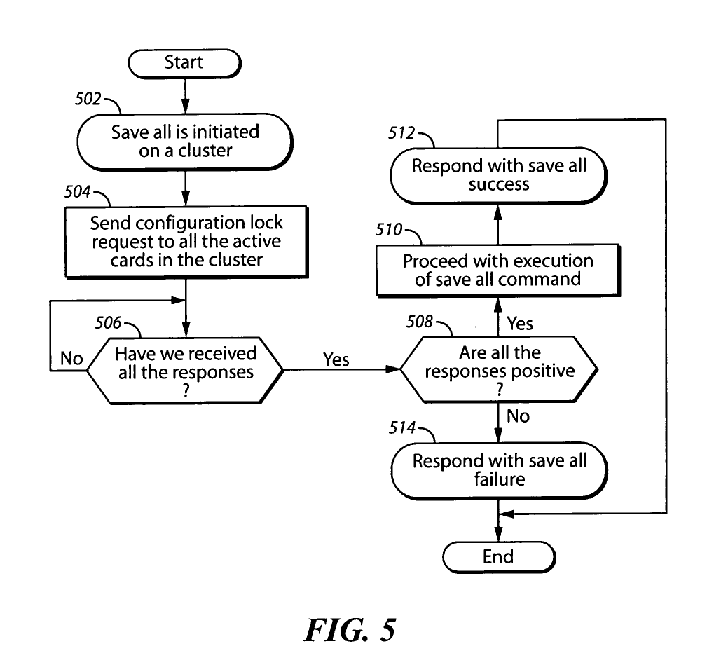

Referring now to FIG. 5, one example of an approach for saving configuration information is described. At step 502, a save all configuration information command is initiated at a cluster (e.g., from the system manager). At step 504, a configuration lock request is sent to all active members of the cluster. At step 506, it is determined whether responses have been received from all of the cards. If the answer is negative, then control returns to step 506. If the answer is affirmative, then execution continues at step 508.

At step 508, it is determined whether all of the responses are positive. If the answer is negative, then execution continues at step 514 where the system manager responds with a save all failure message. If the answer at step 508 is affirmative, at step 510 execution of the save command proceeds. At step 512, a save all success response is generated and sent to the system manager.

Thus, approaches are provided that allow synchronization to be achieved across cards in a cluster thereby allowing a single IP address to be used to access all cards of the cluster. Synchronization is maintained even as configuration information is changed, new cards are added, and configuration information is saved. As a result of these advantages, faster and more efficient network operations are possible.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of synchronizing configuration of a plurality of application cards operating in a cluster, comprising:
at one of the plurality of application cards operating in the cluster:
compiling a textual Management Information Base (MIB) file into a compiled file, the compiled file comprising shared objects and unshared objects;
storing the compiled file in a data base;
receiving a Simple Network Management Protocol (SNMP) command that identifies a target object;
comparing the target to the shared objects in the compiled file in the database; and
when a match exists between the target object and a shared object in the database, replicating the SNMP command using a backplane to access all others of the plurality of application cards operating in the cluster and performing an operation on any instance of the target object on the all others of the plurality of application cards.

2. The method of claim 1 wherein performing comprises performing an operation selected from a group comprising reading an object-to-be-read and modifying an object-to-be-modified.

3. The method of claim 1 wherein performing comprises modifying an object-to-be-modified and further comprising testing the object-to-be-modified on all others of the plurality of application cards in the cluster to determine whether the modifying can be performed successfully.

4. The method of claim 3 further comprising not changing the any instance object-to-be-modified when the testing indicates that the modifying cannot be successful.

5. The method of claim 3 further comprising changing the any instance of the object-to-be-modified when the testing indicates the modifying can be successful on the all others of the application cards.

6. The method of claim 1 further comprising locking the shared objects in the compiled file in the database when a new application card is added to the cluster.

7. The method of claim 1 further comprising locking shared objects in the compiled file in the database when the shared objects are being saved.

8. The method of claim 1 wherein compiling comprises compiling a textual file comprising non-shared objects.

9. The method of claim 1 wherein compiling comprises compiling a textual file comprising shared objects.

10. The method of claim 1 further comprising gathering a result of the performing the operation and presenting the result.

11. The method of claim 10 wherein presenting the result comprises presenting the result to an entity selected from a group comprising: a Command Line Interface (CLI) and a user of a SNMP interface.

12. An application card associated with a cluster of other application cards comprising:
a database comprising shared and unshared objects;
a Simple Network Management Protocol (SNMP) interface;
a command line interface (CLI);
a backplane interface; and
a distribution agent coupled to the SNMP interface, the CLI, the database, and the backplane, the distribution agent being programmed to receive CLI commands via the CLI and SNMP client requests from the SNMP interface, the agent further being programmed to identify a target object in the CLI commands and SNMP client requests, the agent being further programmed to compare the target object to the shared objects in the database, and the agent being further programmed to send a performance request via the backplane interface to the other application cards of the cluster when a match exists between the object-to-be-modified and a shared object in the database.

13. The application card of claim 12 wherein the performance request is selected from a group comprising: a request to modify an object and a request to read an object.

14. The application card of claim 12 wherein the request is a request to modify an object and wherein the distribution agent is further programmed to determine when the request has been performed successfully on the other application cards of the cluster.

15. The application card of claim 12 wherein the distribution agent is further programmed to lock the shared objects in the database when a new application card is added to the cluster.

16. The application card of claim 12 wherein the distribution agent is further programmed to lock the shared objects in the database when the shared objects are being saved.

17. A method of attaching a property to an object comprising:
receiving an object;
attaching a property to the object, the property selected from a group comprising a shared property and an unshared property; and
sending the object to a data base.

18. The method of claim 17 wherein receiving the object comprises receiving an object in a textual file.

19. The method of claim 18 wherein attaching a property comprises parsing the textual file to determine the property of the object.

20. The method of claim 17 wherein sending the object to the data base comprises sending the object to the data base in a compiled file.

21. The method of claim 17 wherein receiving the object comprises receiving the object in a textual MIB file.
